(19) United States
(12) Patent Application Publication
(10) Pub. No.: US 2025/0184674 A1
(43) Pub. Date: Jun. 5, 2025

(54) IN-USE FEEDBACK PATH CHARACTERIZATION FOR HEARING DEVICE

(71) Applicant: Starkey Laboratories, Inc., Eden Prairie, MN (US)

(72) Inventors: Parth Mishra, The Colony, TX (US); Henning Schepker, Oldenburg (DE)

(21) Appl. No.: 18/953,788

(22) Filed: Nov. 20, 2024

Related U.S. Application Data
(60) Provisional application No. 63/604,360, filed on Nov. 30, 2023.

(51) Int. Cl. H04R 25/00

(52) U.S. Cl. CPC H04R 25/453; H04R 25/353; H04R 25/43; H04R 25/554; H04R 25/70; H04R 2225/41; H04R 2225/55

(57) ABSTRACT

A feedback cancellation function is operable to cancel feedback through a receiver of the hearing device. An audible indicator to a user of the hearing device is emitted via the receiver. The audible indicator has a primary purpose unrelated to characterization of the feedback cancellation function. A response of the audible indicator is detected at a microphone of the hearing device while the hearing device is being worn by the user. Subsequent feedback path characterization data of the hearing device is determined based on the response. The feedback cancellation function uses the subsequent feedback path characterization data.

### RELATED PATENT DOCUMENTS

This application claims the benefit of U.S. Provisional Application No. 63/604,360, filed on Nov. 30, 2023, which is incorporated herein by reference in its entirety.

### SUMMARY

This application relates generally to ear-level electronic systems and devices, including hearing aids, personal amplification devices, and hearables. In one embodiment, a hearing device, includes, a receiver, a microphone, and a feedback cancellation circuit. The feedback cancellation circuit is configurable by setting one or more parameters based on feedback path characterization data of the hearing device, and is operable to cancel feedback through the receiver based on currently-used parameters. A user interface of the device is operable to emit an audible indicator to a user via the receiver. The audible indicator having a primary purpose unrelated to characterization of feedback cancellation. A feedback path characterization circuit of the hearing device determines subsequent feedback path characterization data based on detecting a response of the audible indicator via the microphone. The subsequent feedback path characterization data is used to calculate subsequent parameters for use by the feedback cancellation circuit.

The figures and the detailed description below more particularly exemplify illustrative embodiments.

### BRIEF DESCRIPTION OF THE DRAWINGS

The discussion below makes reference to the following figures.

FIG. 1 is an illustration of a hearing device in an ear according to an example embodiment;

FIG. 2 is a block diagram showing feedback cancellation and characterization functions according to an example embodiment;

FIGS. 3 and 4 are flowcharts showing feedback characterization functions according to example embodiments;

FIG. 5 is a graph showing indicator tone frequency distribution according to an example embodiment;

FIG. 6 is a flowchart of a method according to an example embodiment; and

FIG. 7 is a block diagram of a hearing device and system according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to herein as “hearing aids,” “hearing devices,” and “ear-wearable devices”), such as hearables (e.g., wearable earphones, ear monitors, and earbuds), hearing aids, hearing instruments, and hearing assistance devices, typically include an enclosure, such as a housing or shell, within which internal components are disposed.

Embodiments described herein relate to managing feedback in an ear-wearable device. Acoustic feedback occurs due to the acoustic coupling of a hearing aid receiver and a microphone, creating a closed loop system. Once the feedback reaches a threshold level, the system becomes unstable emitting howling or chirping sounds into the user's ear. Feedback poses a significant challenge in hearing aid technology as it limits amplification capabilities and degrades sound quality. A hearing device may include a feedback canceller that reduces or eliminates the negative effects of feedback, helping to ensure good performance and user satisfaction.

Because feedback paths will vary among users and devices, a feedback canceller initialization is performed during fitting. A feedback canceller initialization program sends an audio signal through the receiver of the hearing device and measures a response through one or more microphones, which establishes a relationship between the receiver and microphone. These measurements are used to compute operating parameters for feedback cancellation, e.g., maximum stable gain and the so-called bulk delay. Typically, the feedback canceller initialization is performed as a manually-initiated measurement (e.g., by a clinician) during the fitting process of the hearing aid, e.g., utilizing a broadband stimulus.

The current practice of a one-time feedback canceller initialization computation during fitting overlooks the dynamic nature of feedback path and its variations in different acoustic environments and during different activities of the hearing aid wearer. If feedback characterization occurs more often during use of the device, the feedback cancelling system can more effectively deal with dynamic changes in the acoustic environment, through user activity and in response to individual user needs.

In this disclosure, a hearing device is described that performs real-time feedback canceller initialization-type computation during everyday operation while being used in the ear. By utilizing indicator tones of the hearing aid and employing broadband or sub-band estimation techniques over multiple intervals, such a device can improve long-term accuracy, adaptability, and personalization in feedback management, ultimately enhancing hearing aid performance. For purposes of this disclosure, the use of the term ‘tone,’ ‘indicator tone,’ and the like are not intended to limit the embodiments to pure tone or mixed tone indicators. Other audible signals may be used as indicators, such as voice indications, noise-like signals, music, simulated object sounds (e.g., bells, water drops), etc.

Also for purposes of this disclosure, the terms “feedback characterization,” “feedback path characterization,” or “feedback cancellation characterization” may be used as interchangeable with “feedback canceller initialization.” The term “characterization” generally indicates that the procedure can be performed at ongoing intervals during use and not necessarily an initial setup. The term “characterization” also indicates that the process does not necessarily need to initialize, reinitialize, or change the feedback cancellation system (e.g., stored parameters), although it may under some conditions.

A feedback canceller algorithm employed in a hearing device may model the acoustic feedback path using an adaptive filter that is subsequently used to provide an estimate of the acoustic feedback in the microphone. This estimate is then subtracted from the microphone signal to provide a feedback free signal that is used for further processing (e.g., amplification, noise reduction, etc.) in the hearing aid. One challenge for such adaptive filter is the appropriate choice of the step-size which trades off between a) slow adaptation to changes in the acoustic feedback path but good modelling accuracy in unchanged acoustics paths and b) fast adaptation to changes in the acoustic feedback path but less accurate modelling in unchanged acoustic paths. The techniques described herein can provide input to these adaptive algorithms, e.g., to maintain good modeling accuracy over time.

In some embodiments, feedback path characterization data is measured using one or more hearing aid indicator tones as the excitation signal. This approach provides a reliable and controllable signal source for feedback path characterization computation. In some embodiments, the indicator tones are selected such that each indicator tone only a different (e.g., narrow) frequency range. In this way, assuming all indicator tones are used relatively frequently, they can jointly cover the complete relevant frequency range. The feedback path characterization data obtained in this way can serve as an input for several other algorithms in the hearing aid. With in-use measurements, repeated over time, these algorithms can provide enhanced and up-to-date performance data.

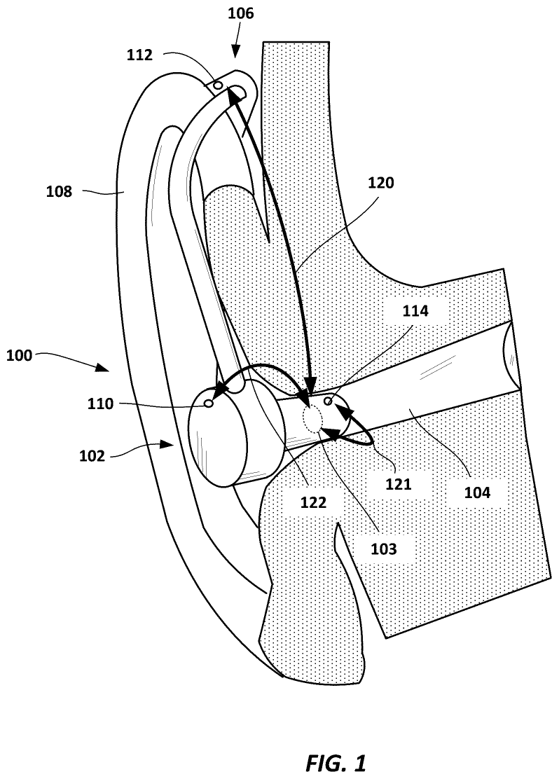

In FIG. 1, a diagram illustrates an example of an ear-wearable device 100 according to an example embodiment. The ear-wearable device 100 includes an in-ear portion 102 that fits into the ear canal 104 of a user/wearer. The ear-wearable device 100 may also include an external portion 106, e.g., worn over the back of the outer ear 108. The external portion 106 is electrically and/or acoustically coupled to the internal portion 102.

The in-ear portion 102 may include an acoustic transducer 103, although in some embodiments the acoustic transducer may be in the external portion 106, where it is acoustically coupled to the ear canal 104, e.g., via a tube. The acoustic transducer 103 may be referred to herein as a “receiver,” “loudspeaker,” etc., however could include a bone conduction transducer. One or both portions 102, 106 may include an external microphone, as indicated by respective microphones 110, 112. If the device has an external portion 106, it may have two microphones 112 (e.g., front and rear microphones).

The device 100 may also include an internal microphone 114 that detects sound inside the ear canal 104. The internal microphone 114 may also be referred to as an inward-facing microphone or error microphone. Other components of hearing device 100 not shown in the figure may include a processor (e.g., a digital signal processor or DSP), memory circuitry, power management and charging circuitry, one or more communication devices (e.g., one or more radios, a near-field magnetic induction device), one or more antennas, buttons and/or switches, for example. The hearing device 100 can incorporate a long-range communication device, such as a Bluetooth® transceiver or other type of radio frequency (RF) transceiver.

While FIG. 1 shows one example of a hearing device, often referred to as a hearing aid (HA), the term hearing device of the present disclosure may refer to a wide variety of ear-level electronic devices that can aid a person with or without impaired hearing. This includes devices that can produce processed sound for persons with normal hearing, such as noise addition/cancellation to treat misophonia. Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

Acoustic feedback occurs due to the acoustic coupling of the hearing aid receiver 103 and at least one of the microphones 110, 112, 114, creating a closed loop system. The term feedback is often associated with an audio path instability once the feedback reaches a threshold level, however feedback also exists in a stable system. A feedback path is an acoustic coupling path between receiver and microphones. Examples of feedback paths 120-122 are indicated by bold lines in the figure. Note that feedback paths can exist between any combination of microphones 110, 112, 114 and the receiver 103, and the depiction of a single microphone in subsequent diagrams is not meant to limit the embodiments to only one microphone or to a single feedback path associated therewith.

As noted above, one or more of the feedback paths 120-122 can be measured during an initial fitting, and used to set parameters of the feedback controller. The initial fitting feedback canceller calibration in such a case is solely initiated by the clinician and not adjustable by the user. In some cases, the accuracy and reliability of the clinical feedback canceller initialization is less than ideal. For example, patients often struggle to replicate the precise fit achieved by the clinician. Therefore a sub-optimum fit later adopted by the user can lead to inconsistent feedback cancellation operation. This inconsistency compromises the effectiveness of the hearing experience and can cause performance issues.

Schemes have been developed to allow the patient to perform feedback characterization on their own, e.g., to initiate a test procedure via a user interface. This can provide the user control over updating or modifying the feedback characteristics to match their evolving needs. A user-controllable test may still have some issues, such as instances where the feedback characterization is mistakenly measured. For example, if the test is unintentionally run while the hearing device is on a table, this could result in adverse impacts on the product's performance.

In embodiments described below, an in-use measurement process is described that uses hearing aid indicator signals while the device is being worn. This approach allows for individualization by enabling the feedback canceller (and possibly other audio processing circuits) to be updated and customized based on the user's specific requirements and changing circumstances. This personalized approach can optimize the hearing device for each user's unique needs. The use of indicator signals allows the measurements to be made regularly without user-intervention, or even the user being aware that such measurements are being performed.

The measurements are made over time while the hearing device is being used, which facilitates continuous monitoring and feedback. By constantly monitoring changes in the user's condition, early detection of any issues becomes possible. If certain changes are detected that cannot be corrected using parameter adjustment, appropriate actions can be taken, such as prompting the user to visit the clinician or running or more involved characterization and adjustment procedure. This approach can promptly address issues with the device, maintaining a consistent and reliable hearing experience. In-use testing can alleviate feedback issues caused by factors like long hair or wearing caps, as the feedback responses are accurately measured in the user's ear in real-time.

The use of indicator signals to characterize the feedback response avoids the use of sometimes unpleasant sounds such as broadband noise. It also alleviates the need to have the user repeatedly access a user interface to initiate the testing, because the tones used in the testing are occasionally emitted for purposes unrelated to feedback characterization testing. For example, indicator tones may be played in response to the user activating a user interface control, such as a button. The indicator tones may also be played in response to other events, such as a pairing conformation when wirelessly coupling a mobile device to the hearing device.

In order to provide more effective test results, multiple different indicator signals can be considered jointly such that they collectively cover a broad frequency range. For example, the indicator tone for a switch between three stored memory settings can be used to emit tones or signals that cover five different ranges, as indicated in Table 1 below. Similarly, a first indicator tone may cover several distinct frequencies regions that, where at least one but not all frequency regions overlap with the distinct frequency regions of a second indicator signal. This can be extended to multiple partly overlapping indicator signals in a straightforward way.

TABLE 1

| From Memory | To Memory | Frequency Range |
|---|---|---|
| 1 | 2 | 0 kHz-2 kHz |
| 2 | 3 | 2 kHz-4 kHz |
| 3 | 1 | 4 kHz-6 kHz |
| 3 | 2 | 6 kHz-8 kHz |
| 2 | 1 | 8 kHz-10 kHz |

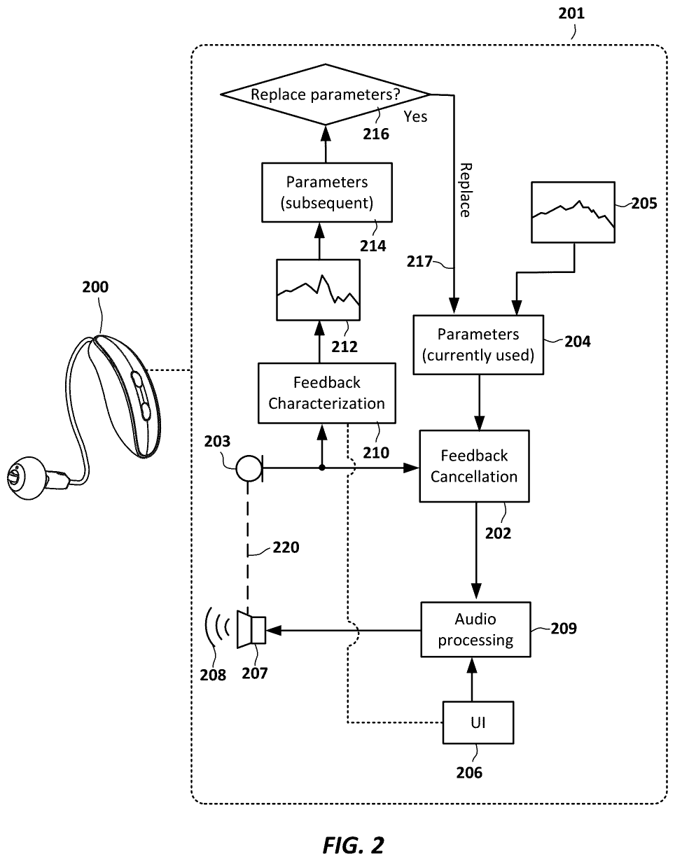

In FIG. 2, a block diagram shows the implementation of the feedback path characterization data in an operational hearing device 200 according to an example embodiment. Block 201 represents hardware, firmware, and software components operable on the hearing device 200, including a microphone 203 and a receiver 207. A feedback cancellation (FBC) circuit 202 is configurable by setting one or more parameters 204 based on feedback path characterization data 205 of the hearing device 200. The feedback characterization data 205 is a frequency response or similar data set that numerically characterizes acoustic properties of a feedback path 220 between the microphone 203 and the receiver 207. The one or more parameters 204 could include any combination of a filter coefficient, maximum stable gain, bulk delay, etc. Additionally, the hearing aid gain could be adjusted if a reduction in maximum stable gain is observed compared to the previous parameter set. The feedback cancellation circuit 202 is operable to cancel feedback through the receiver 207 based on currently-used parameters 204, which are at least partially derived from the feedback characterization data 205, e.g., during a fitting or from a previous, in-use test.

A user interface 206 is operable to emit (e.g., via an audio processing element 209) an audible indicator 208 to a user via the receiver 207. The audible indicator 208 has a primary purpose unrelated to characterization of feedback cancellation. This primary purpose may include user-interface confirmation tones, alert or reminder tones/messages, etc. The audible indicator 208 may be played synchronously with user inputs (e.g., in response to a user-initiated mode change and/or setting change) or asynchronously with and independent of user input (e.g., a low battery alert, Bluetooth pairing tone, incoming device alert such as phone call ring tone, an internally triggered mode/settings change).

A feedback path characterization circuit 210 determines subsequent feedback path characterization data 212 based on detecting a response of the audible indicator 208 via the microphone 203. This response and the associated subsequent feedback path characterization data 212 will be affected by a current state of the feedback path 220, which may change over time and/or under certain conditions. The subsequent feedback path characterization data 212 is used to calculate subsequent parameters 214 for the feedback cancellation circuit 202.

As indicated at block 216, the feedback path characterization circuit 210 (or other functional module) determines whether the subsequent parameters 214 should replace the currently-used parameters 204. If so, the replacement of parameters is indicated by replacement path 217, after which the feedback cancellation circuit 202 uses the subsequent parameters 214. Note that if multiple currently-used parameters 204 are changeable over time, the replacement 217 may change a subset of the parameters.

While the feedback path characterization circuit 210 is shown updating operational parameters of the feedback cancellation circuit 202, other functions may be also or instead be updated based on the feedback path characterization data 212. For example, a change in the feedback path 220 may indicate conditions that could affect general acoustic coupling and performance of the hearing device 200. Therefore, other audio processing functions could be changed based on these measurements. Examples of such audio processing functions include equalization, dynamic range compression/expansion, speech enhancement, noise cancellation, occlusion cancellation, reverberation mitigation, etc.

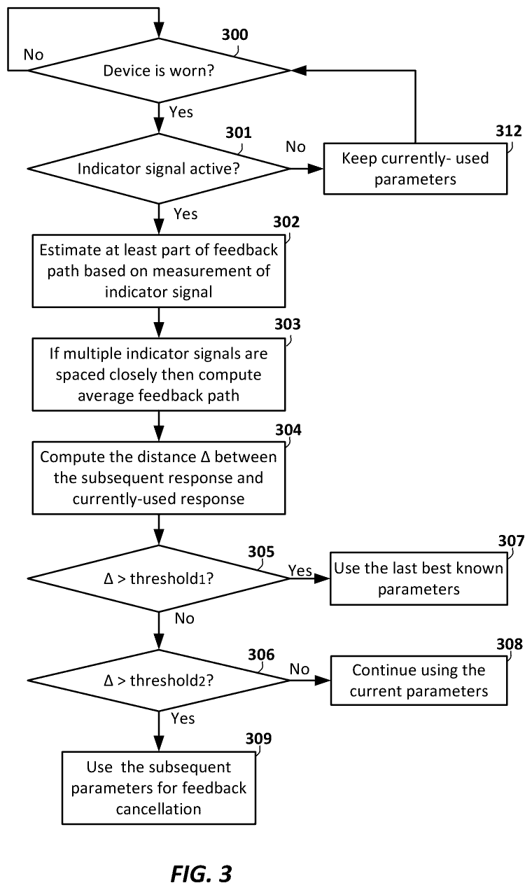

In FIG. 3, a flowchart shows a method according to an example embodiment. This method may be representative of a continuous process (e.g., infinite loop) operational on a hearing device. The method is invoked when the device is worn, e.g., on the head, ears, etc., as represented by testing block 300. If the device is being worn, another test block 301 checks to see if an indicator signal is active. If not, no changes are made and the outer loop repeats. If an indicator signal is active, then at least part of the feedback path is estimated (block 302) based on measurement of the indicator signal, e.g., via one or more outward facing microphones. This measurement is used to obtain a subsequent response (e.g., a feedback transfer function), which is “subsequent” in that it occurs at a later time than when the currently-used parameters were determined, e.g., the parameters used in block 312.

At block 303, if multiple indicator signals are detectable and spaced closely (in time and/or frequency) then an average feedback path is measured and used for the subsequent response/transfer function. Using multiple measurements can provide for a more accurate and/or robust estimate. For example, if a user causes multiple subsequent increases in volume, resulting in the same indicator sound being played, then all of these indicator sounds can be averaged to increase accuracy around a single reference point. This refers to signals that are close in time, where time can be on the scale of a few minutes. Another example is the use of multiple different indicators, e.g., first volume increase then volume decrease. Here these indicators may be to close in time (similarly as above) but they can also have a difference in in frequency and may have at least one overlapping frequency region. In this way, the overlapping frequencies can be averaged to improve accuracy around that frequency, as well as characterizing broader frequency ranges outside the overlap.

Once the current response/transfer function is calculated, a distance Δ is computed 304 between the subsequent response calculated at blocks 302 or 303, and the currently-used response. If the distance Δ exceeds a first threshold (threshold₁) as determined at block 305, then the last best known parameters (e.g., the currently-used parameters) are used for feedback cancellation, as indicated at block 307. In these blocks 305, 307, the subsequent response may have been measured under unusable conditions (e.g., device out of ear) and so may be discarded. In some embodiments, a return of ‘yes’ from block 305 may cause the user to be alerted that there was something wrong in a routine self-test that may be due to fitting or some other condition where the hearing device was left on. If it is a condition that can be positively determined, e.g., hearing device is in a charger, then there may be no need to inform the user, as this is one of the expected scenarios in which the device may be active but not in use, e.g., not in the ear.

At block 306, the distance Δ is checked to see if it is large enough to warrant changing the parameters for feedback cancellation, as indicated at block 309. Note that if block 306 is reached, the distance Δ is already below the first threshold, so the distance is checked against a second threshold (threshold₂) at block 306. If the distance is not greater than the second threshold, the current parameters are used as indicated at block 308. Note that the thresholds used in blocks 305 and 306 may be frequency dependent, e.g., weighted by frequency. In this way, the frequencies for which feedback cancellation is most sensitive can have an outlying effect on whether the parameters should be changed or not.

The thresholds used in blocks 305 and 306 can be tailored to each individual and made time-varying. For example, in the case of a user that interacts frequently with the hearing device (e.g., indicators are emitted relatively often over a time period) such that the device plays indicator sounds frequently, the first threshold (threshold₁) may be decreased. On the other hand, for a user that interacts less with the hearing aid such that the hearing device is playing indicator sounds less frequently over a time period, the threshold₁ may be increased. This personalized threshold selection ensures that the hearing aid system is finely tuned to each user's specific needs and usage patterns.

In FIG. 4, a flowchart shows a method of adjusting feedback adjustment distance thresholds according to an example embodiment. Block 400 is triggered each time a characterization test is completed. At block 401, a time from the current test is compared to previous test times to obtain a time metric. For example, the time metric may be an averaged elapsed time between the last N tests, where N≥1. If the time metric satisfies a first threshold (e.g., is less than time_{ref}) as determined at block 402, then the distance threshold (threshold₁ from FIG. 3 in this example) is decreased at block 403. If the time metric satisfies a second threshold (e.g., is greater than time_{ref}) as determined at block 404, then the distance threshold is increased at block 405. A similar process may be used instead or in addition to adjust threshold₂ in FIG. 3.

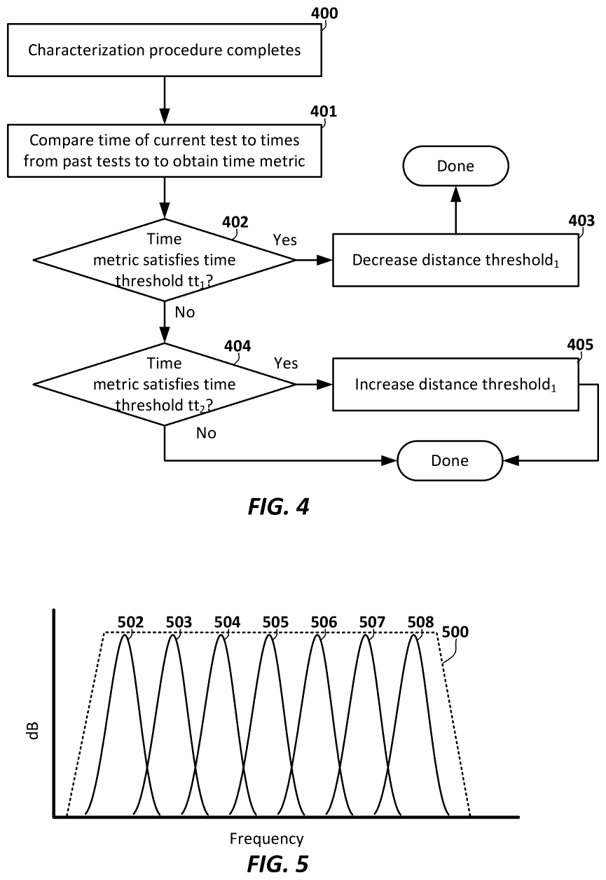

In FIG. 5, a diagram shows how multiple indicators can be composited to determine a response according to an example embodiment. A dotted line indicates a response range 500 that is subject to testing in a feedback path characterization procedure. Curves represent narrowband spectra 502-508 of different test indicators that may be played through the hearing device in response to different events. Each of the different spectra 502-508 is at a different center frequency. In this example, the center frequencies are evenly distributed, e.g., along a logarithmic scale. In other case, the distribution could be unevenly distributed, e.g., it could have a tighter distribution of tones in a first part of the full spectrum range 500 and a wider distribution in a second part of the spectrum. In some case, a single indicator may use a combination of different tone center frequencies, e.g., one indicator tone may combine tones with spectra 503 and 506.

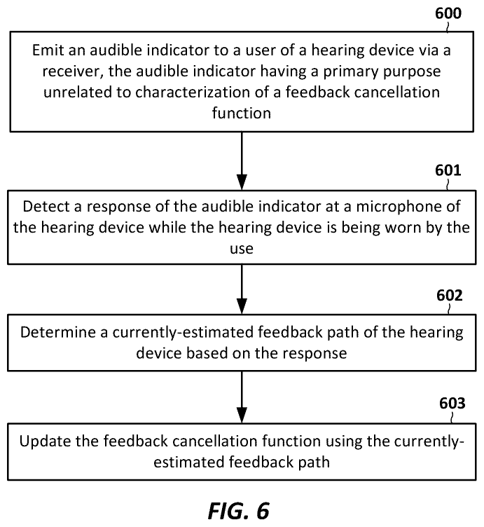

In FIG. 6, a flowchart shows a method of updating a feedback cancellation function of a hearing device according to an example embodiment. The feedback cancellation function is operable to cancel feedback through a receiver of the hearing device. The method involves emitting 600 an audible indicator to a user of the hearing device via the receiver. The audible indicator has a primary purpose unrelated to characterization of the feedback cancellation function. A response of the audible indicator at a microphone of the hearing device is detected 601 while the hearing device is being worn by the user. A currently-estimated feedback path of the hearing device is determined 602 (e.g., calculated by a signal processing circuit) based on the response. The currently-estimated feedback path is used to update 603 the feedback cancellation function.

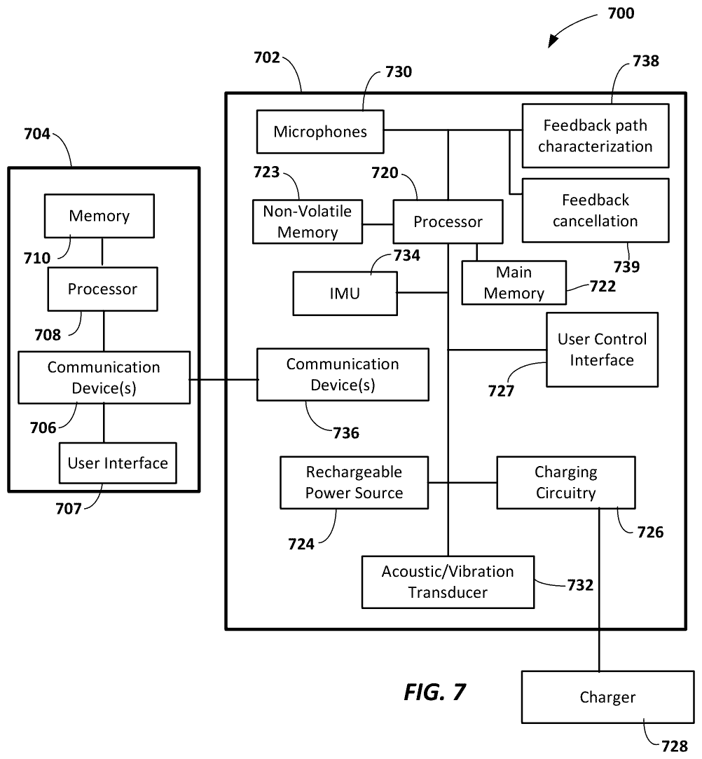

In FIG. 7, a block diagram illustrates a system and ear-worn hearing device 700 in accordance with any of the embodiments disclosed herein. The hearing device 700 includes a housing 702 configured to be worn in, on, or about an ear of a wearer. The hearing device 700 shown in FIG. 7 can represent a single hearing device configured for monaural or single-ear operation or one of a pair of hearing devices configured for binaural or dual-ear operation. The hearing device 700 shown in FIG. 7 includes a housing 702 within or on which various components are situated or supported. The housing 702 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 700 includes a processor 720 operatively coupled to a main memory 722 and a non-volatile memory 723. The processor 720 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 720 can include or be operatively coupled to main memory 722, such as RAM (e.g., DRAM, SRAM). The processor 720 can include or be operatively coupled to non-volatile (persistent) memory 723, such as ROM, EPROM, EEPROM or flash memory. As will be described in detail hereinbelow, the non-volatile memory 723 is configured to store instructions (e.g., module 738) that detect and mitigate vibrations for ANC subsystems.

The hearing device 700 includes an audio processing facility (also referred to as an audio processor circuit) operably coupled to, or incorporating, the processor 720. The audio processing facility includes audio signal processing circuitry (e.g., analog front-end, analog-to-digital converter, digital-to-analog converter, DSP, and various analog and digital filters), a microphone arrangement 730, and an acoustic/vibration transducer 732 (e.g., loudspeaker, receiver, bone conduction transducer, motor actuator). The microphone arrangement 730 can include one or more discrete microphones or a microphone array(s) (e.g., configured for microphone array beamforming). Each of the microphones of the microphone arrangement 730 can be situated at different locations of the housing 702. It is understood that the term microphone used herein can refer to a single microphone or multiple microphones unless specified otherwise.

At least one of the microphones 730 may be configured as a reference microphone producing a reference signal in response to external sound outside an ear canal of a user. Another of the microphones 730 may be configured as an error microphone producing an error signal in response to sound inside of the ear canal. The acoustic transducer 732 produces amplified sound inside of the ear canal.

The hearing device 700 may also include a user interface with a user control interface 727 operatively coupled to the processor 720. The user control interface 727 is configured to receive an input from the wearer of the hearing device 700. The input from the wearer can be any type of user input, such as a touch input, a gesture input, or a voice input. The user control interface 727 may be configured to receive an input from the wearer of the hearing device 700.

The hearing device 700 also includes a feedback path characterization module 738 operably coupled to the processor 720. The feedback path characterization module 738 can be implemented in software, hardware (e.g., specialized neural network logic circuitry, general purpose processor), or a combination of hardware and software. During operation of the hearing device 700, the feedback path characterization module 738 can be used to perform self-tests that include sending one or more indicator sounds/tones through the acoustic transducer 732 and sensing a response at one or more microphones 730. The response includes (or is used to calculate or derive) a transfer function of one or more feedback paths. The module 738 may be integrated with a feedback cancelling module 739 or implemented separately.

The feedback cancelling module 739 operates with the feedback path characterization module 738 to receive the derived transfer function (also referred to herein as a feedback path response) and determine one or more parameters for use by the feedback cancelling module 739. The parameters may be used by the feedback cancelling module 739 for feedback cancellation going forward if the transfer function differs from a previously determined transfer function by some threshold amount. The feedback path characterization module 738 may interact with an IMU 734 to determine significant movement and/or an operating context of the hearing device 700, e.g., in-ear, out-of-ear, etc., which can affect whether the feedback path measurement is performed and/or if it should be disregarded for purposes of updating the feedback cancellation module 739 if the measurement was performed. For example, significant changes to the feedback path while significant movements are occurring may result in unreliable path measurements.

The hearing device 700 can include one or more communication devices 736. For example, the one or more communication devices 736 can include one or more radios coupled to one or more antenna arrangements that conform to an IEEE 702.7 (e.g., Wi-Fi®) or Bluetooth® (e.g., BLE, Bluetooth® 4.2, 5.0, 5.1, 5.2 or later) specification, for example. In addition, or alternatively, the hearing device 700 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 736 may also include wired communications, e.g., universal serial bus (USB) and the like.

The communication device 736 is operable to allow the hearing device 700 to communicate with an external computing device 704, e.g., a mobile device such as smartphone, laptop computer, etc. The external computing device 704 may also include a device usable by a clinician in a clinical setting, such as a desktop computer, test apparatus, etc. The external computing device 704 includes a communications device 706 that is compatible with the communications device 736 for point-to-point or network communications. The external computing device 704 includes its own processor 708 and memory 710, the latter which may encompass both volatile and non-volatile memory. A user interface 707 facilitates interactions between the external computing device 704 and the hearing device 700, including triggering indicator tones used by feedback path characterization module 738. The external computing device 704 may perform some functions described herein associated with the audio processor circuit, such as determining a feedback transfer function, calculating new parameters, adjusting thresholds, etc.

The hearing device 700 also includes a power source, which can be a conventional battery, a rechargeable battery (e.g., a lithium-ion battery), or a power source comprising a supercapacitor. In the embodiment shown in FIG. 7, the hearing device 700 includes a rechargeable power source 724 which is operably coupled to power management circuitry for supplying power to various components of the hearing device 700. The rechargeable power source 724 is coupled to charging circuitry 726. The charging circuitry 726 is electrically coupled to charging contacts on the housing 702 which are configured to electrically couple to corresponding charging contacts of a charger 728 when the hearing device 700 is placed in the charger. Status of the charging circuitry 726 (e.g., device in charger) may be communicated to the feedback path characterization module 738 to assist in determining a context of the device 700, e.g., indicative that the device is within a charger such that the calculation of feedback path responses should be suppressed or and measurements made of those paths should be ignored for purposes of updating the feedback cancellation module 739.

This document discloses numerous example embodiments, including but not limited to the following:

Example A1 is a hearing device, comprising: a receiver and a microphone; a feedback cancellation circuit that is configurable by setting one or more parameters based on feedback path characterization data of the hearing device, the feedback cancellation circuit operable to cancel feedback through the receiver based on currently-used parameters; a user interface operable to emit an audible indicator to a user via the receiver, the audible indicator having a primary purpose unrelated to characterization of feedback cancellation; and a feedback path characterization circuit that determines subsequent feedback path characterization data based on detecting a response of the audible indicator via the microphone, the subsequent feedback path characterization data being used to calculate subsequent parameters for use by the feedback cancellation circuit.

Example A2 includes the hearing device of example A1, wherein the primary purpose of the audible indicator is to provide confirmation to the user of an action taken by the user via the user interface. Example A3 includes the hearing device of example A2, wherein the user action comprise one or more of a settings change to the hearing device and a mode change of the hearing device. Example A4 includes the hearing device of examples A1-A3, wherein the primary purpose of the audible indicator is to provide the user with a status update of the hearing device independent of user input. Example A5 includes the hearing device of example A4, wherein the status update comprises one of an audible battery level indicator, and audible device pairing indicator, and an audible device alert.

Example A6 includes the hearing device of any previous A example, wherein the user interface is operable to emit a plurality of different audible indicators via the receiver to the user, the plurality of audible indicators having respective different primary purposes unrelated to the feedback cancellation, the feedback path characterization circuit estimating parts of the currently-used feedback path characterization data for each of the different audible indicators. Example A7 includes the hearing device of example A6, wherein the plurality of audible indicators each comprise one or more primary frequencies, the primary frequencies of all of the audible indicators being distributed over an operating frequency range of the feedback cancellation circuit.

Example A8 includes the hearing device of any previous A example, wherein if the subsequent feedback path characterization data is different from the currently-used feedback path characterization data by a first threshold, the one or more parameters used by the feedback cancellation circuit are changed to correspond to the subsequent parameters.

Example A9 includes the hearing device of example A8, wherein if the subsequent feedback path characterization data is different from the currently-used feedback path characterization data by greater than a second threshold, the one or more parameters used by the feedback cancellation circuit are not changed to correspond to the subsequent parameters, the second threshold being greater than the first threshold. Example A10 includes the hearing device of example A8, wherein the first threshold is adjusted based on how often the audible indicator is emitted over a time period. Example A11 includes the hearing device of example A10, wherein the first threshold is decreased in response to an increase in how often the audible indicator is emitted over the time period.

Example A12 includes the hearing device of any previous A example, wherein the audible indicator comprises a narrowband signal comprising at least one center frequency, and wherein the subsequent feedback path characterization data comprises an estimate of a feedback transfer function at frequencies different from the center frequency.

Example B13 is a method of updating a feedback cancellation function of a hearing device, the feedback cancellation function operable to cancel feedback through a receiver of the hearing device. The method comprising: emitting an audible indicator to a user of the hearing device via the receiver, the audible indicator having a primary purpose unrelated to characterization of the feedback cancellation function; detecting a response of the audible indicator at a microphone of the hearing device while the hearing device is being worn by the user; determining a subsequent feedback path characterization data of the hearing device based on the response; and updating the feedback cancellation function using the subsequent feedback path characterization data.

Example B14 includes the method of example B13, further comprising calculating one or more subsequent parameters of the feedback cancellation function based on the subsequent feedback path characterization data, and wherein updating the feedback cancellation function comprises causing the feedback cancellation function to use the one or more subsequent parameters for feedback estimation. Example B15 includes the method of example B14, wherein, if the subsequent feedback path characterization data is different from currently-used feedback path characterization data by a first threshold, the one or more subsequent parameters are used by the feedback cancellation function. Example B16 includes the method of example B15, wherein if the subsequent feedback path characterization data is different from the currently-used feedback path characterization data by a second threshold, the one or more subsequent parameters are not used by the feedback cancellation function, the second threshold being greater than the first threshold. Example B17 includes the method of example B15, wherein the first threshold is adjusted based on how often the audible indicator is emitted over a time period. Example B18 includes the method of example B17, wherein the first threshold is decreased in response to an increase in how often the audible indicator is emitted over the time period.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A hearing device, comprising:
a receiver and a microphone;
a feedback cancellation circuit that is configurable by setting one or more parameters based on feedback path characterization data of the hearing device, the feedback cancellation circuit operable to cancel feedback through the receiver based on currently-used parameters;
a user interface operable to emit an audible indicator to a user via the receiver, the audible indicator having a primary purpose unrelated to characterization of feedback cancellation; and
a feedback path characterization circuit that determines subsequent feedback path characterization data based on detecting a response of the audible indicator via the microphone, the subsequent feedback path characterization data being used to calculate subsequent parameters for use by the feedback cancellation circuit.

2. The hearing device of claim 1, wherein the primary purpose of the audible indicator is to provide confirmation to the user of an action taken by the user via the user interface.

3. The hearing device of claim 2, wherein the user action comprise one or more of a settings change to the hearing device and a mode change of the hearing device.

4. The hearing device of claim 1, wherein the primary purpose of the audible indicator is to provide the user with a status update of the hearing device independent of user input.

5. The hearing device of claim 4, wherein the status update comprises one of an audible battery level indicator, and audible device pairing indicator, and an audible device alert.

6. The hearing device of claim 1, wherein the user interface is operable to emit a plurality of different audible indicators via the receiver to the user, the plurality of audible indicators having respective different primary purposes unrelated to the feedback cancellation, the feedback path characterization circuit estimating parts of the currently-used feedback path characterization data for each of the different audible indicators.

7. The hearing device of claim 6, wherein the plurality of audible indicators each comprise one or more primary frequencies, the primary frequencies of all of the audible indicators being distributed over an operating frequency range of the feedback cancellation circuit.

8. The hearing device of claim 1, wherein if the subsequent feedback path characterization data is different from the currently-used feedback path characterization data by a first threshold, the one or more parameters used by the feedback cancellation circuit are changed to correspond to the subsequent parameters.

9. The hearing device of claim 8, wherein if the subsequent feedback path characterization data is different from the currently-used feedback path characterization data by greater than a second threshold, the one or more parameters used by the feedback cancellation circuit are not changed to correspond to the subsequent parameters, the second threshold being greater than the first threshold.

10. The hearing device of claim 8, wherein the first threshold is adjusted based on how often the audible indicator is emitted over a time period.

11. The hearing device of claim 10, wherein the first threshold is decreased in response to an increase in how often the audible indicator is emitted over the time period.

12. The hearing device of claim 1, wherein the audible indicator comprises a narrowband signal comprising at least one center frequency, and wherein the subsequent feedback path characterization data comprises an estimate of a feedback transfer function at frequencies different from the center frequency.

13. A method of updating a feedback cancellation function of a hearing device, the feedback cancellation function operable to cancel feedback through a receiver of the hearing device, the method comprising:
emitting an audible indicator to a user of the hearing device via the receiver, the audible indicator having a primary purpose unrelated to characterization of the feedback cancellation function;
detecting a response of the audible indicator at a microphone of the hearing device while the hearing device is being worn by the user;
determining a subsequent feedback path characterization data of the hearing device based on the response; and
updating the feedback cancellation function using the subsequent feedback path characterization data.

14. The method of claim 13, further comprising calculating one or more subsequent parameters of the feedback cancellation function based on the subsequent feedback path characterization data, and wherein updating the feedback cancellation function comprises causing the feedback cancellation function to use the one or more subsequent parameters for feedback estimation.

15. The method of claim 14, wherein, if the subsequent feedback path characterization data is different from currently-used feedback path characterization data by a first threshold, the one or more subsequent parameters are used by the feedback cancellation function.

16. The method of claim 15, wherein if the subsequent feedback path characterization data is different from the currently-used feedback path characterization data by a second threshold, the one or more subsequent parameters are not used by the feedback cancellation function, the second threshold being greater than the first threshold.

17. The method of claim 15, wherein the first threshold is adjusted based on how often the audible indicator is emitted over a time period.

18. The method of claim 17, wherein the first threshold is decreased in response to an increase in how often the audible indicator is emitted over the time period.
